(19) United States
(12) Patent Application Publication
(10) Pub. No.: US 2025/0338899 A1
(43) Pub. Date: Nov. 6, 2025

(54) UNLOCKING AN AEROSOL-GENERATING SYSTEM FOR USE

(71) Applicant: Philip Morris Products S.A., Neuchatel (CH)

(72) Inventors: Loic SAMSON, Morges (CH); Andrew James MCLAUCHLAN, Poliez-Le-Grand (CH); Nicolas GUEVARA, Chavannes-près-Renens (CH); Karl BAUMGARTNER, Renens (CH)

(73) Assignee: Philip Morris Products S.A., Neuchatel (CH)

(21) Appl. No.: 19/126,294

(22) PCT Filed: Nov. 2, 2023
(86) PCT No.: PCT/EP2023/080591

§ 371 Date: May 1, 2025

(30) Foreign Application Priority Data
Nov. 10, 2022 (EP) 22206745.6

(51) Int. Cl. A24F 40/53; A24F 40/65

(52) U.S. Cl. CPC A24F 40/53; A24F 40/65

(57) ABSTRACT

An aerosol-generating system is provided, in a locked state in which the aerosol-generating system is prevented from generating aerosol, the aerosol-generating system being configured to: receive an unlock grant from an external computing device using connectionless communications, and after receiving the unlock grant, transition the aerosol-generating system from the locked state to an unlocked state in which the aerosol-generating system is allowed to generate aerosol.

The invention relates to an aerosol-generating system having a locked state in which the aerosol-generating system is prevented from generating aerosol and to methods of unlocking the aerosol-generating system for use.

The aerosol-generating system may comprise an aerosol-generating device and optionally also a companion device for storing and/or charging the aerosol-generating device. The aerosol-generating device may be designed as a handheld device that can be used by a user for consuming, for instance in one or more usage sessions, aerosol generated by an aerosol-generating article. The aerosol-generating article may comprise an aerosol-forming substrate, such as a tobacco containing substrate, often in the form of a stick. The stick can be configured in shape and size to be inserted at least partially into the aerosol-generating device, which may comprise a heating element for heating the aerosol-forming substrate. Other exemplary aerosol-generating articles may comprise a cartridge containing a liquid that can be vaporized during aerosol consumption by the user. Such cartridges can also be configured in shape and size to be inserted at least partially into the aerosol-generating device. Alternatively, the cartridge may be fixedly mounted to the aerosol-generating device and refilled by inserting liquid into the cartridge.

It is desirable to perform youth access prevention (YAP) methods to prevent underage users from accessing and using such aerosol-generating devices. Existing YAP methods commonly require a Bluetooth Low Energy (BLE) connection to unlock an aerosol-generating system for use. The aerosol-generating system must pair correctly with an external computing device such as a smartphone or PC, which exchanges information with a server to obtain an unlock grant for unlocking the aerosol-generating system. The inventors have recognized that some aerosol-generating systems have difficulty in successfully completing the BLE pairing process, particularly with Android-based external computing devices. Prior to the commercial launch of the aerosol-generating system, exhaustive testing is performed to identify and resolve any BLE incompatibilities. However, new external computing devices are released throughout the lifetime of the aerosol-generating system, while even previously compatible devices can become incompatible after firmware updates. Undertaking action to resolve such incompatibilities is time consuming and expensive and typically requires modification of the firmware of the aerosol-generating system. Until the new firmware is released, affected systems cannot be unlocked using BLE. Even once the firmware updated is released, affected systems cannot be updated using BLE due to the pairing issue.

It is therefore preferable to provide apparatus and methods for unlocking aerosol-generating systems which mitigate or overcome the problems caused by BLE pairing incompatibilities with various external computing devices, or other kinds of connection difficulties, or the need to install and use a dedicated unlock app.

According to a first aspect, there is therefore provided an aerosol-generating system in a locked state in which the aerosol-generating system is prevented from generating aerosol. The aerosol-generating system may be configured to transmit an unlock request to an external computing device using connectionless communications. The aerosol-generating system may be further configured to: receive an unlock grant from the external computing device using connectionless communications; and, after receiving the unlock grant, transition the aerosol-generating system from the locked state to an unlocked state in which the aerosol-generating system is allowed to generate aerosol.

In some examples described herein, the unlock grant is issued by an entity that is capable of determining whether the user is authorised. The server described herein is one such entity. In other examples, the unlock grant provides implicit permission to unlock the aerosol-generating system, based for example on the detected proximity of a device which is known to be associated with an authorised user. In this case, usage of the aerosol-generating system can reasonably be assumed to take place under the supervision of the authorised user.

According to a second aspect, there is provided a server. The server may be configured to receive an unlock request identifying an aerosol-generating system in a locked state. The server may be further configured to: determine whether the aerosol-generating system is associated with an authorized user; and, if the aerosol-generating system is associated with an authorized user, transmit an unlock grant comprising the unlock code directly or indirectly to the aerosol-generating system, the unlock grant enabling the aerosol-generating system to transition from the locked state to an unlocked state in which the aerosol-generating system is allowed to generate aerosol.

According to a third aspect, there is provided a computing device. The computing device may be configured to receive an unlock request from an aerosol-generating system using connectionless communications. The computing device may be further configured to: transmit the unlock request to a server; receive an unlock grant from the server; and transmit the unlock grant to the aerosol-generating device using connectionless communications.

According to a fourth aspect, there is provided a system comprising the aerosol-generating system of the first aspect and the computing device of the third aspect. The system of the fourth aspect may further comprise the server of the second aspect.

By exchanging the unlock request and/or the unlock grant using connectionless communications, connection difficulties such as the problems caused by BLE pairing incompatibilities with various external computing devices are mitigated while providing a higher success rate of YAP (Youth Access Prevention) methods. In particular, information can be exchanged between the server and the aerosol-generating device without the need for BLE pairing or association with a WiFi access point. In this way, online YAP methods can be performed via BLE or WiFi packet analysis on all mobile devices even if the aerosol-generating device cannot pair with those devices, or establish a connection thereto, increasing the successful YAP unlock percentage towards 100% from the current low level of 70-80%.

Using connectionless communications as described herein, involving basic features of BLE or WiFi packet analysis, may provide improved compatibility between the aerosol-generating device and external computing devices such as mobile devices, and/or may reduce the need for firmware updates to the aerosol-generating device or dedicated unlock applications, and may reduce user frustration.

By generating a device- and session-unique unlock code using a pre-shared secret and one-time random values, the unlock code cannot be eavesdropped and used for other devices. The unlock code cannot be easily guessed as it is based on device secrets and changes at the start of each unlock process. Additionally, using the pre-shared secret significantly decreases the online YAP execution time (by virtue of fewer bytes and lighter cryptographic algorithms) without impairing security.

By confirming that the user of the aerosol-generating device is a legal age user/legal age smoker (LAU/LAS) using the mobile device (app) and the server, using secure data and account validation processes (for instance, mandatory two factor identification to start the app, credit cart ID, GPS data provided by the mobile device to adjust the legal age to country legislation, and so on), robust youth access prevention can be provided.

The unlock process may readily be made compliant with older versions of BLE and only needs the mobile device to be able to alternate between different generic access profile (GAP) roles (Central and Peripheral), which has been common since about 2015.

Additionally, it may be more power efficient to use the non-connectable advertisement mode (“ADV_NONCONN_IND”) of BLE to transmit advertising data (versus the “connectable” mode).

The unlock request may comprise a unique device identifier identifying the aerosol-generating system. The aerosol-generating system may be configured to include the unique device identifier in the unlock request before transmitting the unlock request. The server may be further configured to determine whether the unique device identifier contained in the received unlock request is associated with an authorized user. More particularly, the server may be configured to use the unique device identifier (UID) to retrieve a device unique serial number (DUSN) which can be linked to only one user account, and to permit unlock of the aerosol-generating system only when the DUSN is linked to the user account of an authorized user. The unlock grant transmitted by the server and received by the aerosol-generating system may also comprise the unique device identifier. The aerosol-generating system may be further configured to validate the unlock code only when the unique device identifier contained in the unlock grant matches that of the aerosol-generating system.

The unlock grant may further comprise an unlock code. The server may be further configured to generate the unlock code and to include the unlock code in the unlock grant. The unlock code may be based at least in part on a pre-shared secret which is unique to the aerosol-generating system. The unlock code may be generated at the server, or derived by the server. The unlock code may be based at least in part on a validation code provided by the aerosol-generating system as part of the unlock request. The server may be further configured to generate the unlock code based at least in part on the validation code contained in the unlock request. The aerosol-generating system may be further configured to validate the unlock code using the pre-shared secret which is unique to the aerosol-generating system, after receiving the unlock grant. The aerosol-generating system may be further configured to transition the aerosol-generating system from the locked state to the unlocked state in response to successfully validating the unlock code. The unlock code may be unique to a current unlock session. This may be implemented by the unlock code being based at least in part on, or comprising, a one-time code (OTC). The OTC may be referred to alternatively as a one-time password (OTP) or one-time authorization code (OTAC). The unlock code may comprise or constitute a message authentication code. More particularly, the unlock code may comprise a hash-based message authentication code.

The aerosol-generating system may be further configured to obtain a validation code for comparison with the unlock code. The validation code may be generated at the aerosol-generating system. In other words, the aerosol-generating system may be further configured to generate the validation code based on which the aerosol-generating system validates the unlock code. The aerosol-generating system may be further configured to include the validation code in the unlock request, and to determine whether the unlock code contained in the unlock grant matches the validation code when validating the unlock code. In other words, the aerosol-generating system may be further configured to validate the unlock code by comparing the unlock code contained in the unlock grant with the validation code, and to transition the aerosol-generating system from the locked state to the unlocked state in response to the unlock code matching the validation code.

The unlock code contained in the unlock grant may be encrypted. The server may be further configured to encrypt the unlock code before transmitting the unlock grant. Likewise, the aerosol-generating system may be further configured to decrypt the encrypted unlock code. More particularly, the server may be further configured to encrypt the unlock code using a symmetric key algorithm, while the aerosol-generating system may also be configured to decrypt the encrypted unlock code using a symmetric key algorithm. The server may be further configured to encrypt the unlock code using a key, while the aerosol-generating system may also be further configured to decrypt the encrypted unlock code using a key. The key that is used to encrypt and/or decrypt the unlock code may be derived at least in part from a pre-shared secret that is unique to the aerosol-generating system. Additionally or alternatively, the key that is used to encrypt and/or decrypt unlock code may be derived at least in part from the unique device identifier. Additionally or alternatively, the key that is used to encrypt and/or decrypt the unlock code may be derived at least in part from a one-time code. The aerosol-generating system may be configured to validate the unlock code only when the encrypted unlock code can be decrypted using the key.

The unlock grant may further comprise a challenge. The challenge may comprise a server challenge. The server may be further configured to generate the challenge for inclusion in the unlock grant. The aerosol-generating system may be configured to validate the unlock code at least partially based on the challenge. More particularly, the aerosol-generating system may be configured to validate the unlock code only when the aerosol-generating system provides a valid response to the challenge.

As used herein, the term “connectionless communications” refers in particular to communications which take place without pairing of devices and without association to access points. Connectionless communications may take place between two end points with messages being sent from one end point to another without prior arrangement, i.e., without first ensuring that the recipient is available and ready to receive data. The term “connectionless communications” is used herein in contrast to communications using a prearranged, fixed data channel, as in the case of connection-oriented communication, referred to herein also as a “connectable” mode. Connectionless communications may comprise multicast and/or broadcast operations in which the same data are transmitted to several recipients in a single transmission. For example, connectionless communications may comprise communications using at least one broadcast/advertising beacon, and/or using at least one broadcast/advertising packet, as in the case of Bluetooth or Bluetooth Low Energy, and as such may be referred to in terms of communications using an advertising mode. In order to be able to both send and receive data using connectionless communications, the aerosol-generating system may be configured to switch between operation in a peripheral mode and operation in a central mode. The aerosol-generating system may be configured to transmit the unlock request when operating in a peripheral mode and to receive the unlock grant when operating in a central mode. Similarly, the computing device may be further configured to switch between operation in a peripheral mode and operation in a central mode. The computing device may be further configured to receive the unlock request when operating in a central mode and to transmit the unlock grant when operating in a peripheral mode. Connectionless communications may alternatively comprise monitoring network traffic using network sniffing or packet analysis, which takes place without any association between the aerosol-generating system and an access point.

As used herein, the term “peripheral mode” refers to a mode or role in which the device advertises its presence and waits for a device operating in central mode to connect to it, whereas the term “central mode” refers to a mode or role in which the device scans for other devices. The terms “central mode” and the “peripheral mode” may refer to pre-connection modes or roles. Post connection, the device operating in central mode may operate as a master and the device operating in peripheral mode may operate as a slave.

The aerosol-generating system may comprise an aerosol-generating device. The aerosol-generating device may be configured or designed as a hand-held device usable by the authorized user to consume an aerosol-generating article, for example during one or more usage sessions (also referred to as “experiences” or “experience sessions”). For instance, an aerosol-generating article usable with the aerosol-generating device can comprise an aerosol-forming substrate, such as a tobacco containing substrate, which may be assembled, optionally with other elements or components, in the form of a stick at least partially insertable into the aerosol-generating device. Additionally or alternatively, an aerosol-generating article usable with the aerosol-generating device can comprise at least one cartridge containing a liquid that can be vaporized during aerosol consumption by the user. Such cartridge can be a refillable cartridge fixedly mounted at the aerosol-generating device or the cartridge can be at least partially inserted into the aerosol-generating device. The aerosol-generating device may alternatively be referred to as a reduced risk device (RRD).

The aerosol-generating system may further comprise a companion device. The companion device may comprise a charging case. The companion device, also describable as an auxiliary device, receiving device, or supporting device, may be configured to store and/or charge the aerosol-generating device. The companion device may be portable. The companion device may be configured for at least partially receiving the aerosol-generating device. For example, the companion device may be configured for being physically coupled to the aerosol-generating device. Such physical coupling can, for example, comprise a mechanical coupling based on an attachment means, such as a hook mechanism, a latch mechanism, a snap-fit mechanism or the like, based on which the aerosol-generating device can be mechanically coupled to the companion device and/or a housing thereof. Additionally or alternatively, the aerosol-generating device can be physically coupled to the companion device based on a magnetic or electromagnetic coupling. Additionally or alternatively, the aerosol-generating device can be at least partially inserted into the companion device, for example, into an opening of the companion device.

For communicating with each other and/or with the external computing device and/or for exchanging data or signals, the aerosol-generating device and/or the companion device may comprise at least one communications interface. The communications interfaces can be configured for wireless communication, for wired communication, or both. For instance, the communications interfaces can be configured for communicative coupling via an Internet connection, a wireless LAN connection, a WiFi connection, a Bluetooth connection including BLE, a mobile phone network, a 3G/4G/5G connection and so on, an edge connection, an LTE connection, a BUS connection, a wireless connection, a wired connection, a radio connection, a near field connection, an IoT connection or any other connection using any appropriate communication protocol.

The aerosol-generating device and/or the companion device may include at least one energy storage for storing electrical energy and/or for supplying the aerosol-generating device with electrical energy. For example, the companion device may be configured to supply electrical energy to the aerosol-generating device to charge the at least one energy storage of the aerosol-generating device. In other words, the companion device may be configured to charge the aerosol-generating device and/or the at least one energy-storage thereof. The at least one energy storage of the aerosol-generating device may, for example, comprise at least one battery, at least one accumulator, at least one capacitor or any other energy storage. The companion device may be configured to supply the energy storage of the aerosol-generating device with electrical energy, when the aerosol-generating device is at least partially received by the companion device. The companion device may comprise one or more batteries for supplying electrical energy to the energy storage of the aerosol-generating device. The companion device may be configured to supply the energy storage of the aerosol-generating device with electrical energy wirelessly, for example based on induction. Additionally or alternatively, the companion device may be configured to supply the energy storage of the aerosol-generating device with electrical energy via one or more electrical connectors between the companion device and the aerosol-generating device. For instance, the aerosol-generating device and the companion device may each include at least one electrical connector for electrically coupling the companion device with the aerosol-generating device, when the aerosol-generating device is at least partially received by the companion device. By way of example, the companion device may comprise an opening for at least partially receiving the aerosol-generating device. By at least partially inserting the aerosol-generating device into the opening, one or more electrical connections may be established between one or more electrical connectors of the aerosol-generating device and the companion device. Additionally or alternatively, the aerosol-generating device may be physically and/or mechanically coupled to the companion device, for example to a housing of the companion device, such that the aerosol-generating device is at least partially received by the companion device and such that one or more electrical connections can be established between the aerosol-generating device and the companion device. Optionally, establishing an electrical connection between the companion device and the aerosol-generating device, for example via the one or more electrical connectors of the aerosol-generating device and the companion device, may establish a communicative coupling and/or a communication connection between the companion device and the aerosol-generating device, for example for transmission of the authentication signal. By way of example, the at least one electrical connector of the companion device may be combined and/or may comprise the communications interface of the companion device. In other words, the at least one electrical connector of the companion device can be configured as communications interface for communicatively coupling the companion device with the aerosol-generating device. Additionally or alternatively, the at least electrical connector of the aerosol-generating device may be combined and/or may comprise the communications interface of the aerosol-generating device. In other words, the at least one electrical connector of the aerosol-generating device can be configured as communications interface for communicatively coupling the aerosol-generating device with the companion device. Accordingly, the authentication signal may be transmitted from the companion device to the aerosol-generating device via the one or more electrical connectors of the companion device and the aerosol-generating device. It should be noted, however, that the communications interface of one or both of the companion device and the aerosol-generating device can be physically separate and independent from the at least one electrical connector of the companion device and/or the aerosol-generating device. A charge cycle may refer to a period of time, in which the aerosol-generating device is continuously supplied with electrical energy by the companion device. During a charge cycle, the at least one energy storage may be partly or entirely charged.

The external computing device may be configured to communicate with the aerosol-generating device and/or the companion device, for example based on exchanging data or information. Generally, the external computing device may be a handheld or portable device. Alternatively, the external computing device may be a stand-alone or fixedly installed device. Further, the external computing device may be in possession of or may be installed at the user or another entity or individual, such as a retail shop. By way of example, the external computing device may refer to a handheld, a smart phone, a personal computer (“PC”), a tablet PC, a notebook, or a computer. The external computing device may comprise a user interface. The external computing device may comprise one or more processors for data processing, such as for processing one or more user inputs received at the user interface. Additionally or alternatively, the external computing device may comprise a data storage and/or memory for storing data, such as for example software instructions, a computer program, and/or other data. Further, the external computing device may comprise a communications interface, communications module and/or communications circuitry for communicatively coupling the external computing device with the aerosol-generating device and/or the companion device, for example via the communications interface thereof. Thus, the external computing device may be configured for wireless and/or wired communication with the aerosol-generating device, with the companion device, or both. For instance, the external computing device may be configured for being communicatively coupled with the aerosol-generating device and/or companion device via an Internet connection, a wireless LAN connection, a WiFi connection, a Bluetooth connection, a mobile phone network, a 3G/4G/5G connection and so on, an edge connection, an LTE connection, a BUS connection, a wireless connection, a wired connection, a radio connection, a near field connection, an IoT connection or any other connection using any appropriate communication protocol.

The unlock code may comprise a MAC address detected in network traffic by the aerosol-generated system, wherein the MAC address is associated with a computing device (e.g., a mobile device) of a user who is known to be authorized, such that the packet comprising the said MAC address, which is suggestive of proximity of the authorized user, constitutes implicit permission to unlock the aerosol-generating system. To that end, the aerosol-generating system may be configured to detect the MAC address in network traffic using packet analysis, for example when operating in a monitoring mode for monitoring network traffic using packet analysis. The aerosol-generating system may be further configured to transition from the locked state to the unlocked state in response to successfully validating the unlock code comprising the MAC address. The validation code may comprise for example a MAC address of a computing device of an authorised user, pre-stored on the aerosol-generating system, for comparison with unlock codes in the form of MAC addresses detected by the aerosol-generating system in network traffic. Matching of the pre-stored MAC address, serving as validation code, with a detected MAC address, serving as unlock code, may thus cause the aerosol-generating system to transition from the locked state to the unlocked state. Thus, the aerosol-generating system may be further configured to validate the unlock code by comparing the detected MAC address with the MAC address of the computing device of the authorised user, and to transition from the locked state to the unlocked state in response to the detected MAC address matching the MAC address of the computing device of the authorised user.

According to a fifth aspect, there is provided a method performed by an aerosol-generating system in a locked state in which the aerosol-generating system is prevented from generating aerosol. The method may comprise transmitting an unlock request to an external computing device using connectionless communications. The method may further comprise: receiving an unlock grant from the external computing device using connectionless communications; and, after receiving the unlock grant, transitioning the aerosol-generating system from the locked state to an unlocked state in which the aerosol-generating system is allowed to generate aerosol.

The method of the fifth aspect may further comprise validating the unlock code using a pre-shared secret which is unique to the aerosol-generating system, after receiving the unlock grant. The method may further comprise transitioning the aerosol-generating system from the locked state to the unlocked state, in response to successfully validating the unlock code. The method may further comprise obtaining a validation code for comparison with the unlock code. The method may further comprise generating the validation code at the aerosol-generating system. The method may further comprise validating the unlock code by comparing the unlock code with the validation code, and transitioning the aerosol-generating system from the locked state to the unlocked state in response to the unlock code matching the validation code. The method may further comprise generating the validation code based on which the aerosol-generating system validates the unlock code. The method may further comprise including the validation code in the unlock request, and determining whether the unlock code contained in the unlock grant matches the validation code when validating the unlock code. In the case that the unlock code contained in the unlock grant is encrypted, the method may further comprise decrypting the encrypted unlock code. The method may further comprise decrypting the encrypted unlock code using a symmetric key algorithm. The method may further comprise decrypting the encrypted unlock code using a key. The key may be derived at least in part from a pre-shared secret, and/or at least in part from the unique device identifier, and/or at least in part from a one-time code. The method may further comprise validating the unlock code only when the encrypted unlock code can be decrypted using the key. The method may further comprise validating the unlock code only when the unique device identifier contained in the unlock grant matches that of the aerosol-generating system. In the case that the unlock grant further comprises a challenge, the method may further comprise validating the unlock code at least partially based on the challenge. The method may further comprise switching between operation in a peripheral mode and operation in a central mode. The method may further comprise transmitting the unlock request when operating in a peripheral mode and receiving the unlock grant when operating in a central mode.

The unlock code may comprise a MAC address detected in network traffic. The method may comprise detecting the MAC address in network traffic, for example using packet analysis, for example when operating in a monitoring mode for monitoring network traffic using packet analysis. The validation code may comprise a MAC address of a computing device of an authorised user. The method may comprise comparing the detected MAC address with the MAC address of the computing device of the authorised user stored on the aerosol-generating system, and transitioning the aerosol-generating system from the locked state to the unlocked state in response to the detected MAC address matching the stored MAC address.

According to a sixth aspect, there is provided a method performed by a server. The method may comprise receiving an unlock request identifying an aerosol-generating system in a locked state. The method may further comprise: determining whether the aerosol-generating system is associated with an authorized user; and, if the aerosol-generating system is associated with an authorized user, transmitting an unlock grant comprising the unlock code directly or indirectly to the aerosol-generating system, the unlock grant enabling the aerosol-generating system to transition from the locked state to an unlocked state in which the aerosol-generating system is allowed to generate aerosol.

In the case that the unlock request comprises a unique device identifier identifying the aerosol-generating system, the method of the sixth aspect may further comprise determining whether the unique device identifier is associated with an authorized user. The method may further comprise generating an unlock code and including the unlock code in the unlock grant. The method may further comprise generating the unlock code based at least in part on a validation code contained in the unlock request. The method may further comprise encrypting the unlock code before transmitting the unlock grant. The method may further comprise encrypting the unlock code using a symmetric key algorithm. The method may further comprise encrypting the unlock code using a key as described herein. The method may further comprise generating a challenge for inclusion in the unlock grant.

According to a seventh aspect, there is provided a method performed by a computing device. The method may comprise receiving an unlock request from an aerosol-generating system using connectionless communications. The method may further comprise: transmitting the unlock request to a server; receiving an unlock grant from the server; and transmitting the unlock grant to the aerosol-generating device using connectionless communications.

The method of the seventh aspect may further comprise switching between operation in a peripheral mode and operation in a central mode. The method may further comprise receiving the unlock request when operating in a central mode and to transmitting the unlock grant when operating in a peripheral mode.

The method of any of the fifth-seventh aspects may be computer-implemented.

According to an eighth aspect, there is provided a computing system configured to perform the method of any of the fifth-seventh aspects.

According to a ninth aspect, there is provided a computer program (product) comprising instructions which, when executed by a computing system, enable or cause the computing system to perform the method of any of the fifth-seventh aspects.

According to a tenth aspect, there is provided a computer-readable (storage) medium comprising instructions which, when executed by a computing system, enable or cause the computing system to perform the method of any of the fifth-seventh aspects. The computer-readable medium may be transitory or non-transitory, volatile or non-volatile.

As used herein, the term “locked state” may refer to a locked configuration of the aerosol-generating device and the term “unlocked state” may refer to an unlocked configuration of the aerosol-generating device. In the locked state or configuration, the aerosol-generating device is prohibited from delivering and/or generating aerosol. This may mean that the aerosol-generating device is locked for aerosol consumption by the user in the locked state and/or that the aerosol-generating device is configured in the locked state, such that no aerosol can be delivered and/or generated. On the other hand, in the unlocked state or configuration, the aerosol-generating device is permitted or allowed to deliver and/or generate aerosol. This may mean that the aerosol-generating device is unlocked for consumption of aerosol by the user in the unlocked state and/or that the aerosol-generating device is configured in the unlocked state, such that aerosol can be delivered and/or generated. Accordingly, when the aerosol-generating device is in the locked state, the aerosol-generating device may not be actuatable by the user to deliver and/or generate aerosol, and, when the aerosol-generating device is in the unlocked state, the aerosol-generating device may be actuatable by the user to deliver and/or generate aerosol. In other words, in the locked state of the aerosol-generating device, access to one or more functions or functionalities of the aerosol-generating device, including aerosol delivery and/or generation, may be prohibited for the user, and in the unlocked state of the aerosol-generating device, access to one or more functions or functionalities of the aerosol-generating device, including aerosol delivery and/or generation, may be permitted for the user. Additionally or alternatively, the companion device may be configured to charge the energy storage of the aerosol-generating device only if there has been a successful authentication of the user. In this example, the locked state may be considered as the state in which the energy storage of the aerosol-generating device does not contain enough charge to cause aerosol to be generated, and the unlocked state may be considered as the state in which the energy storage contains enough charge to cause aerosol to be generated. The authentication signal may then be considered as the provision of charge to the energy storage of the aerosol-generating device by the companion device. In the locked state, the control circuitry may, for example, be configured to prohibit activation of a heating element based on at least one of disabling the at least one heating element, disabling an energy supply for supplying electrical energy to the at least one heating element, and disabling an input element for actuating the at least one heating element by the user.

As used herein, the term “transitioning” may mean entering, configuring and/or switching the aerosol-generating device into the locked or unlocked state, which may mean or comprise actuating and/or configuring the aerosol-generating device such that the aerosol-generating device is in the locked or unlocked state.

As used herein, the term “authentication” refers to verifying the identity of the user.

As used herein, the term “authorization” refers to determining the user's access rights, i.e., their right to transition the aerosol-generating device from the locked state to the unlocked state. Since, in the context of YAP methods, the user's identity is inherently bound to their access rights, the terms “authentication” and “authorization” may be used interchangeably in the present disclosure.

As used herein, the term “authorized user” (also referred to as a “verified user”) can refer to or denote a proprietor of the aerosol-generating device, an adult, an adult individual, a user of full age, a user having reached the age threshold, a user having reached majority age, and/or a user that has been authorized to configure the aerosol-generating device by another authorized user, such as by the proprietor. Further, an unauthorized user can refer to or denote an underage user, a user not having reached an age threshold, a child, or any other user who is unauthorized to configure the aerosol-generating device, in particular unauthorized to transition the aerosol-generating device into the unlocked state for aerosol consumption.

The term “circuitry”, as used herein, may comprise, for example, singly or in any combination, hardwired circuitry, programmable circuitry such as computer processors comprising one or more individual instruction processing cores, state machine circuitry, and/or firmware that stores instructions executed by programmable circuitry. Modules may, collectively or individually, be embodied as circuitry that forms a part of one or more devices or systems as described herein.

The term “obtaining”, as used herein, may comprise, for example, receiving from another system, device, or process; receiving via an interaction with a user; loading or retrieving from storage or memory; measuring or capturing using sensors or other data acquisition devices.

The term “determining”, as used herein, encompasses a wide variety of actions, and may comprise, for example, calculating, computing, processing, deriving, investigating, looking up (e.g., looking up in a table, a database or another data structure), ascertaining, and the like. Also, “determining” may comprise receiving (e.g., receiving information), accessing (e.g., accessing data in a memory), and the like. Also, “determining” may comprise resolving, selecting, choosing, establishing and the like.

The indefinite article “a” or “an” does not exclude a plurality. In addition, the articles “a” and “an” as used herein should generally be construed to mean “one or more” unless specified otherwise or clear from the context to be directed to a singular form.

Unless specified otherwise, or clear from the context, the phrases “one or more of A, B and C”, “at least one of A, B, and C”, and “A, B and/or C” as used herein are intended to mean all possible permutations of one or more of the listed items. That is, the phrase “A and/or B” means (A), (B), or (A and B), while the phrase “A, B, and/or C” means (A), (B), (C), (A and B), (A and C), (B and C), or (A, B, and C).

The term “comprising” does not exclude other elements or steps. Furthermore, the terms “comprising”, “including”, “having” and the like may be used interchangeably herein.

Below, there is provided a non-exhaustive list of non-limiting examples. Any one or more of the features of these examples may be combined with any one or more features of another example, embodiment, or aspect described herein.

Ex.1. An aerosol-generating system in a locked state in which the aerosol-generating system is prevented from generating aerosol, the aerosol-generating system configured to: receive an unlock grant from an external computing device using connectionless communications, and after receiving the unlock grant, transition the aerosol-generating system from the locked state to an unlocked state in which the aerosol-generating system is allowed to generate aerosol.

Ex.1. A The aerosol-generating system according to Ex.1, further configured to transmit an unlock request to the external computing device using connectionless communications.

Ex.2. The aerosol-generating system according to Ex.1A, wherein the unlock request comprises a unique device identifier identifying the aerosol-generating system.

Ex.3. The aerosol-generating system according to Ex.2, wherein the unlock grant comprises the unique device identifier and an unlock code.

Ex.4. The aerosol-generating system according to Ex.3, wherein the unlock code is generated at, or derived by, another external computing device (e.g. a server) or the external computing device (as described herein).

Ex.5. The aerosol-generating system according to Ex.3 or Ex.4, further configured to validate the unlock code using a pre-shared secret which is unique to the aerosol-generating system, after receiving the unlock grant.

Ex.6. The aerosol-generating system according to any one of Ex.3-Ex.5, further configured to transition the aerosol-generating system from the locked state to the unlocked state, in response to successfully validating the unlock code.

Ex.7. The aerosol-generating system of any of claims Ex.3-Ex.6, further configured to obtain a validation code for comparison with the unlock code.

Ex.8. The aerosol-generating system according to Ex.7, wherein the validation code is generated at the aerosol-generating system.

Ex.9. The aerosol-generating system of any of Ex. 3-Ex.8, further configured to validate the unlock code by comparing the unlock code with a validation code, and to transition the aerosol-generating system from the locked state to the unlocked state in response to the unlock code matching the validation code.

Ex.10. The aerosol-generating system of any of Ex.3-Ex.9, further configured to generate a validation code based on which the aerosol-generating system validates the unlock code.

Ex.11. The aerosol-generating system of any of Ex.3-Ex.10, further configured to include a validation code in the unlock request, and to determine whether the unlock code contained in the unlock grant matches the validation code when validating the unlock code.

Ex.12. The aerosol-generating system of any of Ex.3-Ex.11, wherein the unlock code contained in the unlock grant is encrypted, and wherein the aerosol-generating system is configured to decrypt the encrypted unlock code.

Ex.13. The aerosol-generating system of any of Ex.3-Ex.12, wherein the unlock code contained in the unlock grant is encrypted, and wherein the aerosol-generating system is configured to decrypt the encrypted unlock code using a symmetric key algorithm.

Ex.14. The aerosol-generating system of any of Ex.3-Ex.13, wherein the unlock code contained in the unlock grant is encrypted, and wherein the aerosol-generating system is configured to decrypt the encrypted unlock code using a key derived at least in part from a pre-shared secret.

Ex.15. The aerosol-generating system of any of Ex.3-Ex.14, wherein the unlock code contained in the unlock grant is encrypted, and wherein the aerosol-generating system is configured to decrypt the encrypted unlock code using a key derived at least in part from the unique device identifier.

Ex.16. The aerosol-generating system of any of Ex.3-Ex.15, wherein the unlock code contained in the unlock grant is encrypted, and wherein the aerosol-generating system is configured to decrypt the encrypted unlock code using a key derived at least in part from a one-time code.

Ex.17. The aerosol-generating system of any of Ex.14-Ex.16, wherein the unlock code contained in the unlock grant is encrypted, and wherein the aerosol-generating system is configured to validate the unlock code only when the encrypted unlock code can be decrypted using the key.

Ex.18. The aerosol-generating system of any of Ex.3-Ex.17, wherein the unlock code is unique to a current unlock session.

Ex.19. The aerosol-generating system of any of Ex.3-Ex.18, wherein the unlock code is based at least in part on a one-time code.

Ex.20. The aerosol-generating system of any of Ex.3-Ex.19, wherein the unlock code comprises a message authentication code.

Ex.21. The aerosol-generating system of any of Ex.3-Ex.20, wherein the unlock code comprises a hash-based message authentication code.

Ex.22. The aerosol-generating system of any of Ex.3-Ex.21, further configured to validate the unlock code only when a unique device identifier contained in the unlock grant matches that of the aerosol-generating system.

Ex.23. The aerosol-generating system of any of Ex.3-Ex.22, wherein the unlock grant further comprises a challenge, and wherein the aerosol-generating system is configured to validate the unlock code at least partially based on the challenge.

Ex.24. The aerosol-generating system of any preceding example, wherein the aerosol-generating system is configured to switch between operation in a peripheral mode and operation in a central mode.

Ex.25. The aerosol-generating system of any of Ex.1A-24, wherein the aerosol-generating system is configured to transmit the unlock request when operating in a peripheral mode and to receive the unlock grant when operating in a central mode.

Ex.26. The aerosol-generating system of any preceding example, wherein connectionless communications comprise communications using at least one advertising packet.

Ex.27. The aerosol-generating system of any preceding example, wherein connectionless communications comprise communications using at least one broadcast beacon.

Ex.28. The aerosol-generating system according to any preceding example, the system comprising an aerosol-generating device, or an aerosol-generating device and an auxiliary device.

Ex.29. The aerosol-generating system according to Ex.28, wherein the auxiliary device is a charging case.

Ex.30. A server configured to:
determine whether an aerosol-generating system is associated with an authorized user;
if the aerosol-generating system is associated with an authorized user, transmit an unlock grant comprising the unlock code directly or indirectly to the aerosol-generating system, the unlock grant enabling the aerosol-generating system to transition from the locked state to an unlocked state in which the aerosol-generating system is allowed to generate aerosol.

Ex.30A. The server of Ex.30, further configured receive an unlock request identifying the aerosol-generating system in a locked state.

Ex.31. The server of Ex.30A, wherein the unlock request comprises a unique device identifier identifying the aerosol-generating system, wherein the server is further configured to determine whether the unique device identifier is associated with an authorized user.

Ex.32. The server of any of Ex.30-Ex.31, further configured to generate an unlock code and to include the unlock code in the unlock grant.

Ex.33. The server of Ex.32, wherein the unlock code is based at least in part on a pre-shared secret which is unique to the aerosol-generating system.

Ex.34. The server of Ex.32 or Ex.33 when dependent on Ex.30A, further configured to generate the unlock code based at least in part on a validation code contained in the unlock request.

Ex.35. The server of any of Ex.32-Ex.34, further configured to encrypt the unlock code before transmitting the unlock grant.

Ex.36. The server of Ex.35, further configured to encrypt the unlock code using a symmetric key algorithm.

Ex.37. The server of Ex.35 or Ex.36, further configured to encrypt the unlock code using a key derived at least in part from the pre-shared secret.

Ex.38. The server of any of Ex.35-Ex.37, further configured to encrypt the unlock code using a key derived at least in part from a unique device identifier identifying the aerosol-generating system.

Ex.39. The server of any of Ex.35-Ex.38, further configured to encrypt the unlock code using a key derived at least in part from a one-time code.

Ex.40. The server of any of Ex.32-Ex.39, wherein the unlock code is unique to a current unlock session.

Ex.41. The server of any of Ex.32-Ex.40, wherein the unlock code is based at least in part on a one-time code.

Ex.42. The server of any of Ex.32-Ex.41, wherein the unlock code comprises a message authentication code.

Ex.43. The server of any of Ex.32-Ex.42, wherein the unlock code comprises a hash-based message authentication code.

Ex.44. The server of any of Ex.30-Ex.43, further configured to generate a challenge for inclusion in the unlock grant.

Ex.45. A computing device configured to:
receive an unlock grant from a server; and
transmit the unlock grant to an aerosol-generating system using connectionless communications.

Ex.45A. The computing device of Ex.45, further configured to receive an unlock request from the aerosol-generating system using connectionless communications and to transmit the unlock request to the server.

Ex.46. The computing device according to Ex.45A, wherein the unlock request comprises a unique device identifier identifying the aerosol-generating system.

Ex.47. The computing device according to Ex.46, wherein the unlock grant comprises the unique device identifier and an unlock code

Ex.48. The computing device of Ex.47, wherein the unlock code is unique to a current unlock session.

Ex.49. The computing device of Ex.47 or Ex.48, wherein the unlock code is based at least in part on a one-time code.

Ex.50. The computing device of any of Ex.47-Ex.49, wherein the unlock code comprises a message authentication code.

Ex.51. The computing device of any of Ex.47-Ex.50, wherein the unlock code comprises a hash-based message authentication code.

Ex.52. The computing device of any of Ex.47-Ex.51, wherein the unlock code is encrypted, and wherein a key that is used to encrypt and/or decrypt the unlock code is derived at least in part from a pre-shared secret that is unique to the aerosol-generating system.

Ex.53. The computing device of any of Ex.47-Ex.52, wherein the unlock code is encrypted, and wherein a key that is used to encrypt and/or decrypt unlock code is derived at least in part from the unique device identifier.

Ex.54. The computing device of any of Ex.47-Ex.53, wherein the unlock code is encrypted, and wherein a key that is used to encrypt and/or decrypt the unlock code is derived at least in part from a one-time code.

Ex.55. The computing device of any of Ex.47-Ex.54, wherein the unlock code is based at least in part on a validation code provided by the aerosol-generating system as part of the unlock request.

Ex.56. The computing device of any of Ex.45-Ex.55, further configured to switch between operation in a peripheral mode and operation in a central mode.

Ex.57. The computing device of any of Ex.45A-Ex.56, further configured to receive the unlock request when operating in a central mode and to transmit the unlock grant when operating in a peripheral mode.

Ex.58. The computing device of any of Ex.45-Ex.57, wherein connectionless communications comprise communications using at least one advertising packet.

Ex.59. The computing device of any of Ex.45-Ex.58, wherein connectionless communications comprise communications using at least one broadcast beacon.

Ex.60. A system comprising the aerosol-generating system of any of Ex.1-Ex.29 and the computing device of any of Ex.45-Ex.59.

Ex.61. The system of Ex.60, further comprising the server of any of Ex.30-Ex.44.

Ex.62. A method performed by an aerosol-generating system in a locked state in which the aerosol-generating system is prevented from generating aerosol, the method comprising:
receiving an unlock grant from an external computing device using connectionless communications; and
after receiving the unlock grant, transitioning the aerosol-generating system from the locked state to an unlocked state in which the aerosol-generating system is allowed to generate aerosol.

Ex.62A. The method of Ex.62, further comprising transmitting an unlock request to the external computing device using connectionless communications.

Ex.63. The method of Ex.62A, wherein the unlock request comprises a unique device identifier identifying the aerosol-generating system.

Ex.64. The method of Ex.63, wherein the unlock grant comprises the unique device identifier and an unlock code.

Ex.65. The method of Ex.64, wherein the unlock code is generated at, or derived by, another external computing device (e.g. a server) or the external computing device (as described herein).

Ex.66. The method of Ex.64 or Ex.65, further comprising validating the unlock code using a pre-shared secret which is unique to the aerosol-generating system, after receiving the unlock grant.

Ex.67. The method of any of Ex.64-Ex.66, further comprising transitioning the aerosol-generating system from the locked state to the unlocked state, in response to successfully validating the unlock code.

Ex.68. The method of any of Ex.64-Ex.67, further comprising obtaining a validation code for comparison with the unlock code.

Ex.69. The method of Ex.68, further comprising generating the validation code at the aerosol-generating system.

Ex.70. The method of any of Ex.64-Ex.69, further comprising validating the unlock code by comparing the unlock code with a validation code, and transitioning the aerosol-generating system from the locked state to the unlocked state in response to the unlock code matching the validation code.

Ex.71. The method of any of Ex.64-Ex.70, further comprising generating a validation code based on which the aerosol-generating system validates the unlock code.

Ex.72. The method of any of Ex.64-Ex.71, further comprising including a validation code in the unlock request, and determining whether the unlock code contained in the unlock grant matches the validation code when validating the unlock code.

Ex.73. The method of any of Ex.64-Ex.72, wherein the unlock code contained in the unlock grant is encrypted, the method further comprising decrypting the encrypted unlock code.

Ex.74. The method of any of Ex.64-Ex.74, wherein the unlock code contained in the unlock grant is encrypted, the method further comprising decrypting the encrypted unlock code using a symmetric key algorithm.

Ex.75. The method of any of Ex.64-Ex.74, wherein the unlock code contained in the unlock grant is encrypted, the method further comprising decrypting the encrypted unlock code using a key derived at least in part from a pre-shared secret.

Ex.76. The method of any of Ex.64-Ex.75, wherein the unlock code contained in the unlock grant is encrypted, the method further comprising decrypting the encrypted unlock code using a key derived at least in part from the unique device identifier.

Ex.77. The method of any of Ex.64-Ex.76, wherein the unlock code contained in the unlock grant is encrypted, the method further comprising decrypting the encrypted unlock code using a key derived at least in part from a one-time code.

Ex.78. The method of any of Ex.75-Ex.77, wherein the unlock code contained in the unlock grant is encrypted, the method further comprising validating the unlock code only when the encrypted unlock code can be decrypted using the key.

Ex.79. The method of any of Ex.64-Ex.78, wherein the unlock code is unique to a current unlock session.

Ex.80. The method of any of Ex.64-Ex.79, wherein the unlock code is based at least in part on a one-time code.

Ex.81. The method of any of Ex.64-Ex.80, wherein the unlock code comprises a message authentication code.

Ex.82. The method of any of Ex.64-Ex.81, wherein the unlock code comprises a hash-based message authentication code.

Ex.83. The method of any of Ex.64-Ex.82, further comprising validating the unlock code only when a unique device identifier contained in the unlock grant matches that of the aerosol-generating system.

Ex.84. The method of any of Ex.64-Ex.83, wherein the unlock grant further comprises a challenge, the method further comprising validating the unlock code at least partially based on the challenge.

Ex.85. The method of any of Ex.62-Ex.84, further comprising switching between operation in a peripheral mode and operation in a central mode.

Ex.86. The method of any of Ex.62-Ex.85 when dependent on Ex.62A, further comprising transmitting the unlock request when operating in a peripheral mode and receiving the unlock grant when operating in a central mode.

Ex.87. The method of any of Ex.62-Ex.86, wherein connectionless communications comprise communications using at least one advertising packet.

Ex.88. The method of any of Ex.62-Ex.87, wherein connectionless communications comprise communications using at least one broadcast beacon.

Ex.89. A method performed by a server, the method comprising:
determining whether an aerosol-generating system is associated with an authorized user;
if the aerosol-generating system is associated with an authorized user, transmitting an unlock grant comprising the unlock code directly or indirectly to the aerosol-generating system, the unlock grant enabling the aerosol-generating system to transition from the locked state to an unlocked state in which the aerosol-generating system is allowed to generate aerosol.

Ex.89A. The method of Ex.89, further comprising receiving an unlock request identifying the aerosol-generating system in a locked state.

Ex.90. The method of Ex.89A, wherein the unlock request comprises a unique device identifier identifying the aerosol-generating system, the method further comprising determining whether the unique device identifier is associated with an authorized user.

Ex.91. The method of any of Ex.89-Ex.90, further comprising generating an unlock code and including the unlock code in the unlock grant.

Ex.92. The method of Ex.91, wherein the unlock code is based at least in part on a pre-shared secret which is unique to the aerosol-generating system.

Ex.93. The method of Ex.91 or Ex.92 when dependent on Ex.89A, further comprising generating the unlock code based at least in part on a validation code contained in the unlock request.

Ex.94. The method of any of Ex.91-Ex.93, further comprising encrypting the unlock code before transmitting the unlock grant.

Ex.95. The method of Ex.94, further comprising encrypting the unlock code using a symmetric key algorithm.

Ex.96. The method of Ex.94 or Ex.95, further comprising encrypting the unlock code using a key derived at least in part from the pre-shared secret.

Ex.97. The method of any of Ex.94-Ex.96, further comprising encrypting the unlock code using a key derived at least in part from a unique device identifier identifying the aerosol-generating system.

Ex.98. The method of any of Ex.94-Ex.97, further comprising encrypting the unlock code using a key derived at least in part from a one-time code.

Ex.99. The method of any of Ex.91-Ex.98, wherein the unlock code is unique to a current unlock session.

Ex. 100. The method of any of Ex. 91-Ex.99, wherein the unlock code is based at least in part on a one-time code.

Ex.101. The method of any of Ex. 91-Ex.100, wherein the unlock code comprises a message authentication code.

Ex.102. The method of any of Ex.91-Ex.101, wherein the unlock code comprises a hash-based message authentication code.

Ex.103. The method of any of Ex.89-Ex.102, further comprising generating a challenge for inclusion in the unlock grant.

Ex.104. A method performed by a computing device, the method comprising:
receiving an unlock grant from a server; and
transmitting the unlock grant to an aerosol-generating system using connectionless communications.

Ex. 104A. The method of Ex. 104, further comprising receiving an unlock request from the aerosol-generating system using connectionless communications and transmitting the unlock request to the server.

Ex.105. The method according to Ex.104A, wherein the unlock request comprises a unique device identifier identifying the aerosol-generating system.

Ex.106. The method according to Ex.105, wherein the unlock grant comprises the unique device identifier and an unlock code

Ex.107. The method of Ex.106, wherein the unlock code is unique to a current unlock session.

Ex. 108. The method of Ex.106 or Ex.107, wherein the unlock code is based at least in part on a one-time code.

Ex.109. The method of any of Ex.106-Ex.108, wherein the unlock code comprises a message authentication code.

Ex. 110. The method of any of Ex.106-Ex. 109, wherein the unlock code comprises a hash-based message authentication code.

Ex.111. The method of any of Ex.106-Ex.110, wherein the unlock code is encrypted, and wherein a key that is used to encrypt and/or decrypt the unlock code is derived at least in part from a pre-shared secret that is unique to the aerosol-generating system.

Ex.112. The method of any of Ex.106-Ex.111, wherein the unlock code is encrypted, and wherein a key that is used to encrypt and/or decrypt unlock code is derived at least in part from the unique device identifier.

Ex.113. The method of any of Ex.106-Ex.112, wherein the unlock code is encrypted, and wherein a key that is used to encrypt and/or decrypt the unlock code is derived at least in part from a one-time code.

Ex.114. The method of any of Ex.106-Ex.113, wherein the unlock code is based at least in part on a validation code provided by the aerosol-generating system as part of the unlock request.

Ex.115. The method of any of Ex.104-Ex.114, further comprising switching between operation in a peripheral mode and operation in a central mode.

Ex. 116. The method of any of Ex.104A-Ex.115, further comprising receiving the unlock request when operating in a central mode and to transmitting the unlock grant when operating in a peripheral mode.

Ex. 117. The method of any of Ex.104-Ex.116, wherein connectionless communications comprise communications using at least one advertising packet.

Ex.118. The method of any of Ex.104-Ex. 117, wherein connectionless communications comprise communications using at least one broadcast beacon.

Ex.119. A computer program (product) comprising instructions which, when executed by a computing system, enable or cause the computing system to perform the method of any of Ex.62-Ex.118.

Ex.120. A (transitory or non-transitory, volatile or non-volatile) computer-readable (storage) medium comprising instructions which, when executed by a computing system, enable or cause the computing system to perform the method of any of Ex.62-Ex.118.

Ex. 121. The aerosol-generating system according to any of Ex.1-Ex.29, wherein the unlock code comprises a MAC address detected in network traffic.

Ex. 122. The aerosol-generating system according to Ex.121, configured to detect the MAC address in network traffic.

Ex. 123. The aerosol-generating system according to Ex.122, configured to detect the MAC address in network traffic using packet analysis.

Ex.124. The aerosol-generating system according to Ex.123, configured to operate in a monitoring mode for monitoring network traffic using packet analysis.

Ex.125. The aerosol-generating system according to any of Ex.121-Ex.124, wherein the validation code comprises a MAC address of a computing device of an authorised user.

Ex.126. The aerosol-generating system according to Ex.125, further configured to validate the unlock code by comparing the detected MAC address with the MAC address of the computing device of the authorised user, and to transition from the locked state to the unlocked state in response to the detected MAC address matching the MAC address of the computing device of the authorised user.

Ex. 127. The aerosol-generating system according to any of Ex.121-Ex.126, wherein connectionless communications comprise monitoring network traffic using packet analysis.

Ex.128. The method according to any of Ex.62.Ex.88, wherein the unlock code comprises a MAC address detected in network traffic.

Ex.129. The method according to Ex.128, comprising detecting the MAC address in network traffic.

Ex.130. The method according to Ex.129, comprising detecting the MAC address in network traffic using packet analysis.

Ex.131. The method according to Ex.130, comprising operating in a monitoring mode for monitoring network traffic using packet analysis.

Ex.132. The method according to any of Ex.128-Ex.131, wherein the validation code comprises a MAC address of a computing device of an authorised user.

Ex.133. The method according to Ex.132, further comprising validating the unlock code by comparing the detected MAC address with the MAC address of the computing device of the authorised user, and transitioning the aerosol-generating system from the locked state to the unlocked state in response to the detected MAC address matching the MAC address of the computing device of the authorised user.

Ex.134. The method according to any of Ex.128-Ex.133, wherein connectionless communications comprise monitoring network traffic using packet analysis.

The invention may include one or more aspects, examples or features in isolation or combination whether specifically disclosed in that combination or in isolation. Any optional feature or sub-aspect of one of the above aspects applies as appropriate to any of the other aspects.

A detailed description will now be given, by way of example only, with reference to the accompanying drawings, in which:—

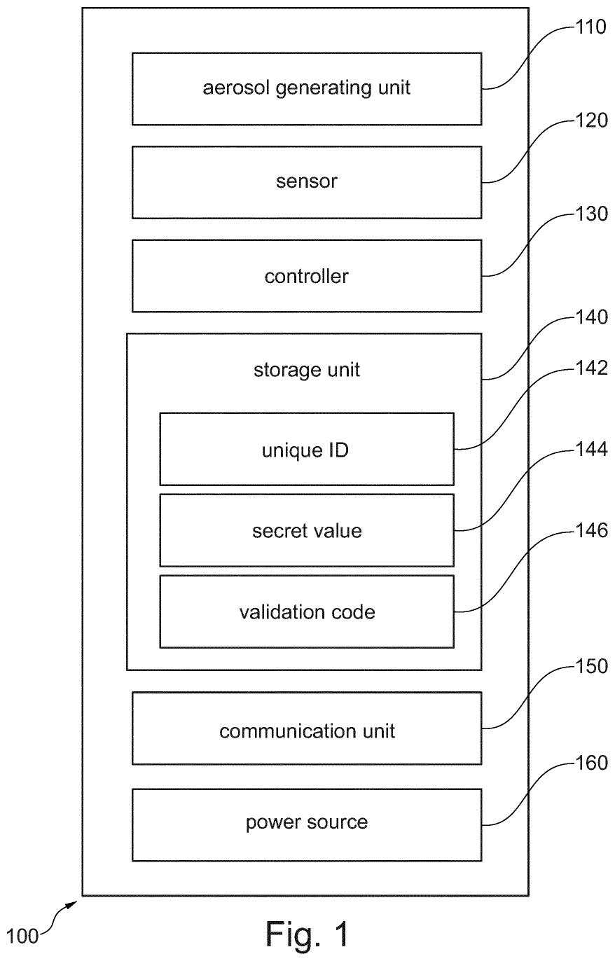

FIG. 1 illustrates an aerosol-generating device;

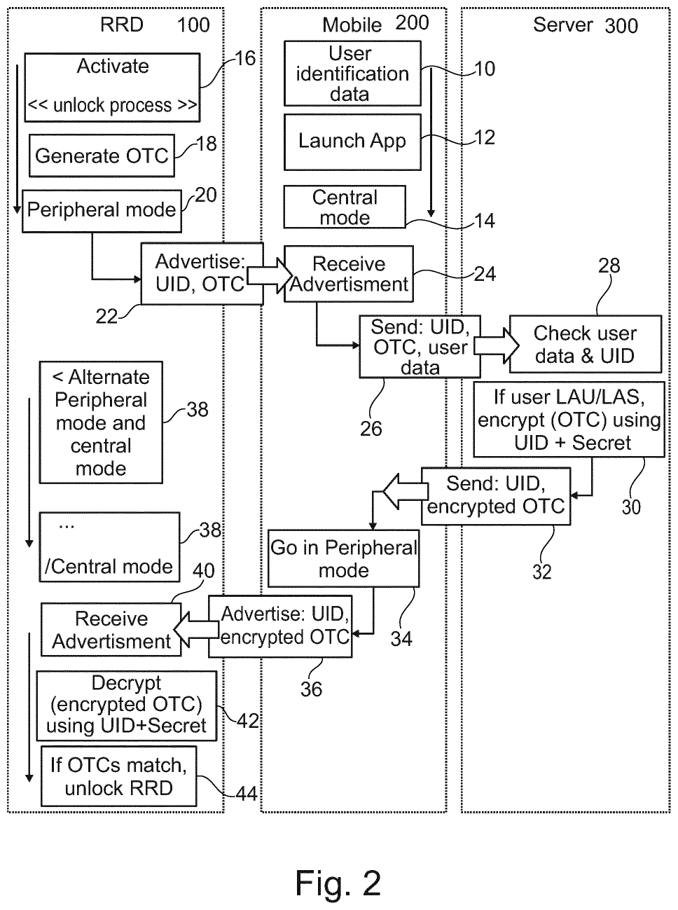

FIG. 2 illustrates a system comprising the aerosol-generating device of FIG. 1, a mobile device, and a server; and

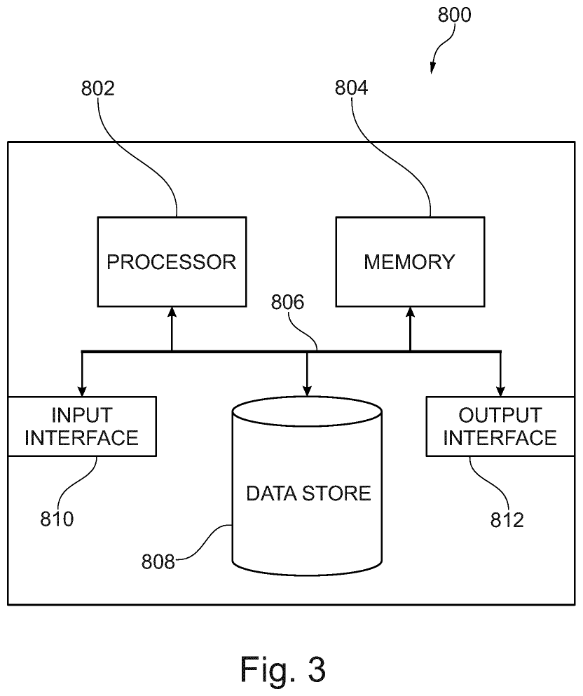

FIG. 3 illustrates a computing system that can be used in accordance with the systems and methods disclosed herein.

FIG. 1 shows a block diagram of an aerosol-generating device 100. The aerosol-generating device 100 may comprise an aerosol-generating unit 110, a sensor 120, a controller 130, a storage unit 140, a communication unit 150, and a power source 160.

The aerosol-generating unit 110 is a unit for generating an aerosol for inhalation by a user of the aerosol-generating device 100 from a precursor material (consumable material). As an example, the aerosol-generating unit 110 may comprise a vaporizer or a heating element. The precursor material may be provided in liquid or solid form. The aerosol-generating unit 110 is powered by electric energy provided by the power source 160 and controlled by the controller 130.

The sensor 120 delivers data that may be used for controlling operation of the aerosol-generating device 100. For example, the sensor may be configured for detecting a user interaction with the aerosol-generating device 100, such as pressing a button, opening or closing of a receptacle for the precursor material, performing a gesture by moving the device 100 in a particular manner, etc. The sensor 120 may also be configured for detecting a puff performed by a user of the aerosol-generating device 100. In another example, the sensor 120 may be configured for detecting a voltage, a current, a resistance, a charge, an energy or a temperature related to an operation of the aerosol-generating unit 110. The sensor 120 may also be configured for detecting a voltage, a current, a resistance, a charge, an energy or a temperature related to the power source 160 of the aerosol-generating device 100 and/or a charging device connected to the aerosol-generating device 100. In a further example, the sensor 120 may be configured for detecting a type or an amount of a consumable material used by the aerosol-generating unit 110.

The controller 130 is in charge of controlling the overall operation of the aerosol-generating device 100, in particular of operating the aerosol-generating unit 110, possibly on the basis of data delivered by the sensor 120, creating, encrypting and storing data in the storage unit 140, receiving and transmitting data via the communication unit 150, monitoring and/or controlling charging of the power source 160, etc. The controller 130 may comprise a computing device, such as that described herein, or a microcontroller. The controller 130 may also be provided with further storage for storing a computer program and/or a memory for storing data related to the execution of the computer program.

The storage unit 140 is connected to the controller 130 and is configured to store therein data relevant to the unlock process such as a unique device identifier 142, a pre-shared secret 144, and/or a validation code 146. The storage unit 140 may be volatile or non-volatile. As an example, a flash memory is provided as the storage unit 140. The storage unit 140 may be an integral part of the controller 130 or a component external to the controller 130. The storage unit 140 may comprise more than one physically or logically separated storage sections or components for storing different data items. The unique device identifier 142, the pre-shared secret 144, and the validation code 146, for instance, may be stored in different sections or components of the storage unit 140. The pre-shared secret 144 may be stored in a section or component that is specifically secured against unauthorized access.

The unique device identifier 142 is a piece of data unique to the aerosol-generating device 100, e.g. a unique device identity (UID) attributed to the device 100 at the manufacturing stage. For example, the aerosol-generating device 100 may be provided with a unique serial number stored as the unique identifier in the storage unit 140. The unique device identifier 142 may also include, in addition to or instead of the serial number, information indicating at least one of a product identifier, a platform identifier, and a manufacturing site. The unique device identifier 142 may also be provided as a unique manufacturing information block (or a manufacturing facility ID), MIB, i.e., as a data block comprising information pertaining to the manufacturing process, such as a product ID, a platform ID, a unique ID (or a serialized device unit ID) and a manufacturing site. In one example, the unique device identifier 142 is a “codentify” value, i.e., a unique, multi-digit alphanumeric code provided at the manufacturing stage and encrypting unique manufacturing/time data.

The pre-shared secret 144 is a value that may be used for deriving an encryption key for encrypting data. The pre-shared secret 144 is secret in the sense that it is generally neither known to the user or any other unauthorized persons nor (readily) derivable from the aerosol-generating device 100 or the data transmitted therefrom or thereto. The pre-shared secret 144 is not included in any data transmissions during regular operation. The pre-shared secret 144 may be stored in a particularly secure part of the storage unit 140 that is not accessible to any external devices. The pre-shared secret 144 is also stored, in association with the respective unique device identifier 142, in a database accessible to a manufacturer server. In this manner, the server may use the unique device identifier 142 in a look-up operation to obtain the pre-shared secret 144 of the aerosol-generating device 100, for example in order to derive a cryptographic key for encrypting and/or decrypting data. Using the thus derived key, the server may decrypt encrypted data received from the aerosol-generating device 100 and/or encrypt data to be transmitted to the aerosol-generating device 100. The pre-shared secret 144 may be a multi-byte value, sufficiently large in order to prevent a brute-force attack on the encrypted data. For example, the pre-shared secret 144 may comprise 8, 16, 32, 64, 128 or 256 bytes of data. Other sizes for the pre-shared secret 144, including sizes that are a power of two or different from a power of two, may also be used. By way of example, a random number or a pseudorandom number generated during the manufacturing process may be used as the pre-shared secret 144. The pre-shared secret 144 may be generated by the aerosol-generating device 100 during the manufacturing process and transmitted, preferably in encrypted form, for example using a public-key cryptosystem like RSA, to a host computer which stores the pre-shared secret 144 in association with the unique device identifier 142 in the database for later reference by the manufacturer server. For example, the device 100 may use the server public key to encrypt the pre-shared secret 144 and the unique device identifier 14, before sending them to the server, which decrypts them using its private key. The pre-shared secret 144 may also be generated by the host computer and transmitted to or directly written into the storage unit 140 during a stage of the manufacturing process.

The validation code 146 comprises any suitable information whereby the aerosol-generating device 100 validates an unlock code contained in an unlock grant, for example in an unlock grant received from the server. The validation code 146 may be generated at the aerosol-generating device 100 or may be generated by an authorized party, e.g., the device manufacturer, who knows the pre-shared secret 144 contained in the aerosol-generating device 100. The validation code 146 may be created and used for validation in many ways. One example involves calculation of the validation code on the aerosol-generating device 100 and calculation in parallel of the unlock code on the server, with the aerosol-generating device then comparing the unlock code received from the server with its own calculated validation code. In this example, the validation code and the unlock code may be calculated based on common information, such as the pre-shared secret and/or on a known timepoint or timeslot. In another example, the validation process involves encryption of the validation code serving as a device challenge (plus an optional server challenge) by the server to create the unlock code with reception, decryption, and comparison with the validation code (plus the optional server challenge) on the aerosol-generating device 100. In yet another example, the validation code comprises a MAC address of a mobile device belonging to an authorized user, as described further hereinbelow.

The communication unit 150 serves as a communications interface for establishing a communication link to external devices, in particular to an external computing device such as a mobile device and/or to the manufacturer server. The communication link may be based on any wired or wireless communication technique, including, but not limited to, a serial communication link, a universal serial bus (USB), an optical communication port, near-field communication (NFC), Bluetooth, Bluetooth low energy (BLE), wireless communication, WiFi according to any of the IEEE 802.11x standards, mobile communication, etc. Communication with the manufacturer server may be direct or indirect, for instance via an intermediary such as the mobile device, a holder or a docking station. Communication with the manufacturer server may also involve more than only one communication protocol, such as for example a Bluetooth connection between the aerosol-generating device 100 and the mobile device and mobile communication between the mobile device and an internet access point.

The power source 160 serves as an energy storage unit which supplies electric power to all components of the aerosol-generating device 100. The power source 160 may be a rechargeable battery, such as lithium ion battery or a lithium polymer battery.

FIG. 2 shows a block diagram of a system comprising the aerosol-generating device 100, an external computing device of the user, which in this example comprises the mobile device 200, and the manufacturer server 300. The aerosol-generating device 100 and the mobile device 200 are connected by a communication link for transmitting data. In one non-limiting example described herein, the communication link between the aerosol-generating device 100 and the mobile device 200 is implemented using Bluetooth Low Energy (BLE). The mobile device 200 may comprise a smartphone, tablet, or PC running dedicated software such as an application (app) or web browser. The mobile device 200 and the server 300 are also connected by a communication link. A communication link is thus formed indirectly between the aerosol-generating device 100 and the server 300 with the mobile device 200 acting as an intermediary. The server 300 has access to the database (not shown) that stores, inter alia, the pre-shared secret 144 for the aerosol-generating device 100 in association with its unique device identifier 142.

The present disclosure relates to a process of unlocking the aerosol-generating device 100 using BLE but without completing a full BLE pairing sequence. The unlock process may be carried out to confirm that the user of the aerosol-generating device 100 is a legal age user/legal age smoker (LAU/LAS). In this way, it is possible to prevent underage access to the nicotine containing aerosol generated by the aerosol-generating device 100 in normal use. However, the unlock process is usable for unlocking any device functionality for any reason. The unlock process uses open properties of BLE (advertising or beacon) to exchange information between the aerosol-generating device 100 and the mobile device 200, and thereby with the server 300, the said information being usable to unlock the aerosol-generating device 100. To this end, each of the aerosol-generating device 100 and the mobile device 200 (in particular, the app) is capable of supporting BLE in both central and peripheral generic access profile (GAP) roles. A device operating in the peripheral role is able to transmit data (in the form of an “advertisement”) which include the identification of the device as well as other information. A device operating in the central role is able to scan such incoming data. Such connectionless communication is typically used before pairing two BLE devices, with one of them advertising its presence and the other reading the advertisement and optionally starting the pairing process to form a connection for subsequent connection-oriented communications.

FIG. 2 also illustrates a first non-limiting example of the unlock process.

In an optional preliminary step of the unlock process, the user at step 10 enters user identification data into the mobile device 200.

When the user is ready to start the unlock process, the user launches a dedicated app (or a generic app) on the mobile device at step 12. Optionally, the app itself then verifies that the user is an LAU/LAS before the unlock process can be activated. This step may involve the user uploading information, e.g. an identity card, via the mobile device 12 so that whether the user is above an age threshold can be verified at the mobile device and/or at a server. If the user is an LAU/LAS, the app invites the user to activate the unlock process, for instance by pressing the button on the aerosol-generating device 100, which at this point is in the locked state, so as to provide a signal to the sensor 120. If multiple locked aerosol-generating devices 100 are present, the user is prompted by the app to choose the correct device. Such an indication could be given by the app only by reading the advertisements sent by the devices, without pairing needed.

At step 14, following launch of the app, the mobile device 200 is placed in central role ready to detect BLE advertisements coming from the aerosol-generating device 100.

At step 16, the user presses the button on the aerosol-generating device 100, as instructed by the app, to activate the unlock process.

At step 18, the aerosol-generating device 100 generates the validation code 146. In this non-limiting example, the validation code 146 comprises a random one-time code (OTC) which changes for each initiated unlock process.

At step 20, the aerosol-generating device 100 is placed in the peripheral role.

At step 22, the aerosol-generating device 100 starts BLE advertising an unlock request containing the unique device identifier 142 (UID) and the OTC 146.

At step 24, the mobile device 200 (and, ultimately, the app) receives the unlock request from the aerosol-generating device 100.

At step 26, the mobile device 200 sends the unlock request containing the UID 142, the OTC 146, and optionally also the user identification data (entered in step 10) to the server 300. Any appropriate means of communication may be used in this step.

At step 28, the server 300 determines whether unlock is permitted for the received UID. For example, the UID 142 is used to retrieve a device unique serial number (DUSN), which can be linked to only one user account. Device unlocking is permitted only when the DUSN has been linked to a user account corresponding with the user identification data, and only when the user is an LAU/LAS. If device unlocking is not permitted, the unlock process may be aborted.

At step 30, if device unlocking is permitted, the server 300 encrypts the OTC 146 using the UID 142 and the pre-shared secret 144.

At step 32, the server 300 sends an unlock grant containing the UID 142 and the encrypted OTC 146 to the mobile device 200. The unlock grant may also optionally include a random value generated by the server 300 as a server challenge.

At step 34, the mobile device 200 enters the peripheral mode.

At step 36, the mobile device 200 advertises the unlock grant containing the UID 142, the encrypted OTC 146, and, if used, the server challenge.

At step 38, following its advertisement of the unlock request in step 22, the aerosol-generating device 100 alternates between peripheral mode and central mode.

At step 40, the aerosol-generating device, in central role, receives the BLE advertisement containing the unlock grant.

At step 42, the aerosol-generating device 100 checks the UID 142 to ensure that the unlock grant is intended for that particular aerosol-generating device 100. If not, the aerosol-generating device 100 ignores the unlock grant. If so, the aerosol-generating device 100 decrypts the encrypted OTC 146 using the UID 142 and the pre-shared secret 144 to obtain a decrypted OTC serving as an unlock code.

At step 44, the aerosol-generating device 100 validates the received unlock code (i.e., the decrypted OTC) by comparing it with the OTC stored on the aerosol-generating device 100, i.e. the OTC that was included in the unlock request. If the OTCs match, the aerosol-generating device 100 transitions to the unlocked state, for example by unlocking lockable functionality.

After the unlock process has completed or aborted, the aerosol-generating device 100 may return to the peripheral role, and continue advertising its UID 142 and optionally also its lock state. The UID 142 and lock state may then be recovered by the mobile device 200 in central role, which may optionally communicate the lock state to the server 300. The lock state may be used by the server 300 in further instances of the unlock process to determine whether to send an unlock grant to the aerosol-generating device 100. Additionally or alternatively, once the device 100 is in the unlocked state, which may be confirmed based on such further advertisements by the device 100 and/or manually in the app, the device 100 may restart in the BLE “connectable” mode allowing for the pairing of the aerosol-generating device 100 with the mobile device 200.

In this non-limiting example, encryption and decryption are performed using a symmetric-key algorithm, for instance AES 128 in CTR Mode. The symmetric-key algorithm uses, for encryption, a major key and an initial value (IV). The major key and the IV may be generated by a key derivation function (KDF) using the UID 142, the pre-shared secret 144, and the OTC 146. The KDF derives one or more cryptographic keys from a key provided as input material as well as parameters known as “salt” and “context”. The KDF may comprise a hash-based key derivation function (HKDF) with HMAC-SHA1 as the hash function. In this example, the HKDF uses the pre-shared secret 144 as the input key material, and the UID 142 and the OTC 146 for the other parameters (salt and context). By using the OTC 146 to create the IV, the IV changes during each encryption process, making the encryption strongly secure.

The following table illustrates the server-side encryption process for encrypting the OTC based on the UID 142 and OTC 146 received in the unlock request.

| Server-side encryption process | Results |
|---|---|
| Obtain the pre-shared secret 144 of the device 100 | Pre-shared secret |
| using its UID 142 | 144 |
| Execute HKDF using the UID 142, secret 144, and | Major key and IV |
| OTC 146 | |
| AES 128 CTR Mode (major key, IV) applied on OTC | Encrypted OTC |
| 146 | |

The following table illustrates the device-side decryption process for decrypting the encrypted OTC received from the server 300 in the unlock grant.

| Device-side decryption process | Results |
|---|---|
| Execute HKDF using the UID 142, secret 144, and | Major key and IV |
| OTC 146 | |
| AES 128 CTR Mode (major key, IV) applied on | Decrypted OTC |
| encrypted OTC | |

In one variant to the non-limiting example described above, the server 300 hashes the encrypted OTC before sending it back, while the aerosol-generating device 100 uses AES to encrypt the initial OTC, then hashes it, before comparing the two hashes and determining that the user is an LAU in response to the two hashes matching.

In a further variant, the aerosol-generating device 100 and the mobile 200 may use BLE scan requests to exchange information. In this case, the aerosol-generating device 100 when in peripheral mode may indicate that it has certain properties, including that it is (or not) a connectable device, or that it is (or not) “scannable”. The mobile device 200 in central mode may then send a scan request (“SCAN_REQ”), which the aerosol-generating device 100 as peripheral can read and reply to (using a scan response packet, “SCAN_RSP”), to add additional information to that contained in the initial advertisement. Thus, in case the payload needed by the unlock process is greater than the payload allowed for the advertisement packet, the aerosol-generating device 100 may indicate that it is “scannable” and use the scan response to pass some or all of the information described above to the mobile device 200. Reciprocally, and in case the encrypted OTC is larger than the advertisement packet size, the mobile device 200 when sending the encrypted OTC to the aerosol-generating device 100 may also use such a “scannable” property to trigger a scan request from the aerosol-generating device 100 to send information to the aerosol-generating device 100 using the scan response.

In a yet further variant, a predetermined code may be used to form the validation/unlock code in place of the OTC of the above-described non-limiting example. In this case, the fixed code may be exchanged in use between the device 100 and the server 300 using a process such as that described above or may be pre-known to both the device 100 and server 300, e.g., from the manufacturing process. The fixed code may comprise, or be based on, the pre-shared secret 144. In such an example, additional contextual information may be used to supplement the fixed code for additional security. For example, the validation/unlock codes may be based on such a fixed code in conjunction with time-varying information known or accessible to both parties, such as a current time of day or current numbered timeslot.

Moreover, it will be appreciated that the unlock process need not necessarily be initiated by the device 100. In one such variant, the mobile device 200 and/or server 300 may initiate the unlock process without the device 100 having to advertise its UID 142 or OTC 146. In such a variant, the device 100 may remain in central mode until it receives the unlock grant from the mobile device 200. The mobile device 200 may initiate the unlock process by sending an unlock request to the server 300, using the UID 142 of the device 100 and/or the user identification data. If the user is authorized, the server 300 may then encrypt the predetermined code already stored in the database (optionally altered using contextual information, as described above) using the UID 142 and pre-shared secret 144, as described above, in order for the device 100 to perform decryption and/or code matching for validation purposes.

In a second non-limiting example of the unlock process, the aerosol-generating device 100 utilizes mobile device MAC address packet detection for YAP activation.

In this example, the aerosol-generating device 100 monitors or ‘sniffs’ network traffic for at least one packet from a specific MAC address, for example that of the mobile device 200, in order to unlock the aerosol-generating device 100 for starting a new experience. Thus, the connectionless communications are implemented in this example using network sniffing, i.e., packet analysis. Detection of the MAC address indicates that the mobile device 200 is sufficiently close to the aerosol-generating device 100 to confirm that the experience is being conducted under the supervision of an authorized user. The MAC address, which is unique for each TCP/IP device, may be pre-stored for this purpose on the aerosol-generating device 100. In this way, the packing including the MAC address of the mobile device 200 of an authorised user is taken as implicit permission to unlock the aerosol-generating device 100, enabling the aerosol-generating device 100 to be unlocked as part of the YAP activation. The detected MAC address serves as an unlock code for unlocking the aerosol-generating device 100, while the MAC address stored on the aerosol-generating device 100 serves as the validation code 146 for validating the unlock code. Matching of the two codes indicates that unlocking is permitted.

In this example, the aerosol-generating device 100 is configured to use WiFi communication, i.e., communication based on the IEEE 802.11 family of standards. Such communication typically involves a centralized access point (AP) that coordinates all communication, with it being necessary for a WiFi-enabled device to associate with the AP in order to receive packets from it. In this example, the aerosol-generating device 100 is configured to receive the unlock grant using connectionless communications by operating its WiFi-enabled communication unit 150 in monitor mode, in which the aerosol-generating device 100 receives all packets in a given frequency range. In monitor mode, the aerosol-generating device 100 is able to monitor MAC addresses of devices that are currently communicating with the AP, even when the aerosol-generating device 100 is not itself associated with the AP. Optionally, the aerosol-generating device 100 may enforce a minimum signal strength (of the signal comprising the pre-stored MAC address) to ensure that the mobile device 200 of the authorized user is sufficiently close. Since multiple WiFi channels may exist, the aerosol-generating device 100 may be configured to monitor them sequentially for a predetermined time period (e.g., 100 ms) to detect the pre-registered MAC address.

In this way, the aerosol-generating device 100 is able to implement YAP using mobile device proximity detection without the need for user intervention or app installation.

It will be appreciated that the use of the MAC address is described for illustrative purposes only and that any address or code which uniquely identifies, and indicates the proximity of, the mobile device 200 of an authorized user may be used instead of, or in addition to, the MAC address, such as a device identifier as used for example in Bluetooth.

FIG. 3 illustrates an exemplary computing system 800 that can be used in accordance with the systems and methods disclosed herein. The computing system 800 may form part of or comprise any desktop, laptop, server, or cloud-based computing system. The computing system 800 includes at least one processor 802 that executes instructions that are stored in a memory 804. The instructions may be, for instance, instructions for implementing functionality described as being carried out by one or more components described herein or instructions for implementing one or more of the methods described herein. The processor 802 may access the memory 804 by way of a system bus 806. In addition to storing executable instructions, the memory 804 may also store conversational inputs, scores assigned to the conversational inputs, etc.

The computing system 800 additionally includes a data store 808 that is accessible by the processor 802 by way of the system bus 806. The data store 808 may include executable instructions, log data, etc. The computing system 800 also includes an input interface 810 that allows external devices to communicate with the computing system 800. For instance, the input interface 810 may be used to receive instructions from an external computer device, from a user, etc. The computing system 800 also includes an output interface 812 that interfaces the computing system 800 with one or more external devices. For example, the computing system 800 may display text, images, etc. by way of the output interface 812.

It is contemplated that the external devices that communicate with the computing system 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing system 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing system 800 may be a distributed system. Thus, for instance, several devices may be in communication by way of a network connection and may collectively perform tasks described as being performed by the computing system 800.

Various functions described herein can be implemented in hardware, software, or any combination thereof. If implemented in software, the functions can be stored on or transmitted over as one or more instructions or code on a computer-readable medium. Computer-readable media include computer-readable storage media. Computer-readable storage media can be any available storage media that can be accessed by a computer. By way of example, and not limitation, such computer-readable storage media can comprise FLASH storage media, RAM, ROM, EEPROM, CD-ROM or other optical disc storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal may be included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

It has to be noted that embodiments of the invention are described with reference to different categories. In particular, some examples are described with reference to methods whereas others are described with reference to apparatus. However, a person skilled in the art will gather from the description that, unless otherwise notified, in addition to any combination of features belonging to one category, also any combination between features relating to different category is considered to be disclosed by this application. However, all features can be combined to provide synergetic effects that are more than the simple summation of the features.

While the invention has been illustrated and described in detail in the drawings and foregoing description, such illustration and description are to be considered exemplary and not restrictive. The invention is not limited to the disclosed embodiments. Other variations to the disclosed embodiments can be understood and effected by those skilled in the art, from a study of the drawings, the disclosure, and the appended claims.

The mere fact that certain measures are recited in mutually different dependent claims does not indicate that a combination of these measures cannot be used advantageously.

Any reference signs in the claims should not be construed as limiting the scope.

The invention claimed is:

1.-15. (canceled)

16. An aerosol-generating system in a locked state in which the aerosol-generating system is prevented from generating aerosol, the aerosol-generating system being configured to:
receive an unlock grant from an external computing device using connectionless communications, and
after receiving the unlock grant, transition the aerosol-generating system from the locked state to an unlocked state in which the aerosol-generating system is allowed to generate aerosol.

17. The aerosol-generating system according to claim 16, wherein the aerosol-generating system is further configured to transmit an unlock request to the external computing device using connectionless communications.

18. The aerosol-generating system according to claim 17, wherein the unlock request comprises a unique device identifier identifying the aerosol-generating system.

19. The aerosol-generating system according to claim 18, wherein the unlock grant comprises the unique device identifier and an unlock code.

20. The aerosol-generating system according to claim 19, wherein the unlock code is generated at a server, or derived by the server.

21. The aerosol-generating system according to claim 19, the aerosol-generating system being further configured to validate the unlock code using a pre-shared secret, which is unique to the aerosol-generating system, after receiving the unlock grant.

22. The aerosol-generating system according to claim 19, the aerosol-generating system being further configured to transition the aerosol-generating system from the locked state to the unlocked state, in response to successfully validating the unlock code.

23. The aerosol-generating system according to claim 19, the aerosol-generating system being further configured to obtain a validation code for comparison with the unlock code.

24. The aerosol-generating system according to claim 23, wherein the validation code is generated at the aerosol-generating system.

25. The aerosol-generating system according to claim 19, the aerosol-generating system being further configured to validate the unlock code by comparing the unlock code with a validation code, and to transition the aerosol-generating system from the locked state to the unlocked state in response to the unlock code matching the validation code.

26. The aerosol-generating system according to claim 19, the aerosol-generating system being further configured to generate a validation code based on which the aerosol-generating system validates the unlock code.

27. The aerosol-generating system according to claim 19, the aerosol-generating system being further configured to include a validation code in the unlock request, and to determine whether the unlock code contained in the unlock grant matches the validation code when validating the unlock code.

28. A server configured to:
determine whether an aerosol-generating system is associated with an authorized user, and
if the aerosol-generating system is associated with an authorized user, transmit an unlock grant comprising the unlock code directly or indirectly to the aerosol-generating system, the unlock grant enabling the aerosol-generating system to transition from the locked state to an unlocked state in which the aerosol-generating system is allowed to generate aerosol.

29. A method performed by a computing device, the method comprising:
receiving an unlock grant from a server; and
transmitting the unlock grant to an aerosol-generating system using connectionless communications.

30. A nontransitory computer-readable medium having stored thereon instructions that, when executed by a computing system, causes the computing system to perform the steps of the method according to claim 29.
